(19) United States
(12) Patent Application Publication
(10) Pub. No.: US 2026/0112825 A1
(43) Pub. Date: Apr. 23, 2026

(54) Connection apparatus for contact-protected connection of two conductors

(71) Applicant: Webasto SE, Stockdorf (DE)

(72) Inventor: Sebastian Stoll, Stockdorf (DE)

(21) Appl. No.: 19/364,632

(22) Filed: Oct. 21, 2025

(30) Foreign Application Priority Data
Oct. 21, 2024 (DE) 102024130614.9

(51) Int. Cl. H01R 4/70; H01M 50/505; H01R 4/00; H01R 4/56

(52) U.S. Cl. CPC H01R 4/70; H01M 50/505; H01R 4/54; H01R 4/56; H01R 2201/26

(57) ABSTRACT

A first connection apparatus for electrically connecting a first conductor to a second conductor, where the first conductor is assigned to the first connection apparatus and the second conductor is assigned to a second connection apparatus, the first connection apparatus comprising the first conductor, an electrically insulating protective cover for insulating the first conductor, an electrically conductive coupling component for electrically coupling the first conductor to the second conductor, and a spacer device.

### CROSS-REFERENCE TO RELATED APPLICATION

This application claims priority to German Application No. DE 102024130614.9 filed on Oct. 21, 2024, which is incorporated herein by reference in its entirety for all purposes.

### TECHNICAL FIELD

The present disclosure relates to a first and a second connection apparatus for a drive battery for electrically connecting a first conductor to a second conductor. The disclosure further relates to a drive battery for an electric vehicle.

### BACKGROUND

To connect electrical components, for example battery cells or battery modules, in a drive battery for an electric vehicle, it is known practice to interconnect cells, modules or other electrical components directly or by means of busbars. This is usually done by means of detachable connections, for example screw connections. In order to protect the assembling worker or operator in charge of installation from electric shocks or health risks that can arise from contact with the electrical components, it is known practice to provide for example voltage-carrying components or their interfaces with electrically insulating contact protection.

The voltage-carrying components may be for example busbars or battery module terminals. In the case of high-voltage systems (>60 V), the maintenance of contact protection (for example according to IPXXB) is relevant for occupational safety. It is often required that the contact protection is maintained both before and after the interfaces are connected. For example, a contact-protection requirement may envisage that what is referred to as a test finger or standard test finger should not reach voltage-carrying components. Furthermore, a contact-protection requirement can envisage that components that can be touched by such a standard test finger are electrically insulated.

Interfaces or terminals of electrical components with contact protection are found for example in DE 10 2014 017 081 A1, DE 10 2014 012 320 B3, DE 10 2013 005 109 A1 and DE 10 2016 200 451 A1.

Conventional technical solutions often have a high complexity in the form of many individual parts requiring laborious pre-assembly. This leads to high costs and can also have an adverse effect on fail-safeness and reliability. In addition, screws and nuts overmoulded with plastic, which are significantly more expensive than conventional standard parts, are often required.

### SUMMARY

Proceeding from the known prior art, an object of the present disclosure is to provide improved connection apparatuses for a drive battery for electrically connecting a first conductor to a second conductor, and an improved drive battery for an electric vehicle.

The object is achieved by an apparatus having the features of Claim 1. Further embodiments will become apparent from the dependent claims, the description and the figures.

Accordingly, a first connection apparatus for a drive battery for electrically connecting a first conductor to a second conductor is proposed. The first conductor is assigned to the first connection apparatus and the second conductor is assigned to a second connection apparatus. The first connection apparatus comprises the first conductor, an electrically insulating protective cover for insulating the first conductor, an electrically conductive coupling component for electrically coupling the first conductor to the second conductor, and a spacer device. The spacer device can change between a basic state, in which the coupling component and the first conductor are spaced apart from one another, and a contacting state, in which the coupling component and the first conductor are in electrical contact. In the basic state, the spacer device is configured to change to the contacting state under the action of a connecting force, and in the contacting state the spacer device is configured to switch to the basic state under the action of a separating force.

The connection apparatuses disclosed herein serve to electrically connect a first (electrical) conductor to a second (electrical) conductor and are suitable for example for use in the high-voltage range (>60 V). The first and the second conductor may for example be in the form of what is referred to as a current rail, conductor rail or busbar. Therefore, the first and the second conductor may be rigid or flexible and can carry high voltages or currents.

The first conductor is assigned to the first connection apparatus by the first connection apparatus for example being fastened to the first conductor or the first conductor being at least partially a constituent part of the first connection apparatus. The second conductor is assigned to the second connection apparatus by the second connection apparatus for example being fastened to the second conductor or the second conductor being at least partially a constituent part of the second connection apparatus. Therefore, the first connection apparatus can form a sub-assembly, for example a first installation sub-assembly, with the first conductor. Furthermore, the second connection apparatus can form a sub-assembly, for example a second installation sub-assembly, with the second conductor.

The electrically insulating protective cover for insulating the first conductor may be made of plastic. Furthermore, the protective cover may have a multi-part structure, for example in order, in the course of a pre-assembly, to particularly easily receive the first electrical conductor and also optionally further components of the first connection apparatus and at the same time to be able to provide good insulation. As an alternative, the protective cover may have a single-piece or one-part design. In the present context, “cover” and “protective cover” can be understood to mean any device for insulating electrical component parts, for example a cladding, enclosure, overmoulding or sheath for electrical component parts.

According to the disclosure, the spacer device is configured to switch to the contacting state under the action of a connecting force. The connecting force can be provided for example in the course of a mechanical connection process for connecting the second connection apparatus to the first connection apparatus, by bringing the second connection apparatus into engagement with the first connection apparatus, with the result that the connecting force acts on a corresponding engagement region on the first connection apparatus. To this end, for example the second conductor can rest against the coupling component and force can be distributed from the assembling worker, i.e. from the installation tool being used, via a second connecting means of the second connection apparatus to a first connecting means, corresponding to the second connecting means, of the first connection apparatus or vice versa, with the result that the first and the second connection apparatus move relatively towards one another. Since the second conductor can rest against the coupling component during the mechanical connection process, the connecting force can be applied to the coupling component. Accordingly, the coupling component can provide the area of action for the connecting force.

If the mechanical connection process has not yet been started, the first connection apparatus is still in the basic state, in which the coupling component is spaced apart from the first conductor. In this way, effective contact protection can be provided before the mechanical connection process is performed.

The use of an electrically insulated installation tool makes it possible to ensure the contact protection throughout the entire connection process, even if the installation tool and the connecting element are in direct contact.

Since the spacer device is configured to change to the contacting state, in which the coupling component and the first conductor are in electrical contact, under the action of a connecting force, the first connection apparatus can thus establish an electrical connection between the first and the second conductor by means of the coupling component in the course of being mechanically connected to the second connection apparatus. In this way, it can be ensured that the coupling component contacted by the second conductor only electrically contacts the first conductor in the course of a mechanical connection process carried out as intended.

Furthermore, in the context of the present disclosure it has been identified that the proposed spacer device makes it possible to increase the size of the electrical contact surface between the connection partners in comparison with conventional contact protection devices.

Since the spacer device in the contacting state is moreover configured to switch to the basic state under the action of a separating force, in addition to the mechanical connection process it is also possible to make safe a corresponding detachment or separation process, in which the second connection apparatus is detached or separated from the first connection apparatus again. That is to say, under the action of the separating force, the first connection apparatus transitions from the contacting state, in which the first conductor is electrically connected to the second conductor by means of the coupling component, back to the basic state, in which the coupling component is at a spacing from the first conductor by means of the spacer device. Therefore, the first and the second conductor are no longer electrically conductively connected in the re-assumed basic state, even if the second conductor still rests against the coupling component in the course of the corresponding mechanical detachment process.

In this way, it is possible to provide reversible contact protection which protects the operator against electric shocks both during the mechanical connection process and during the mechanical detachment process.

The separating force is a force, opposed to the connecting force, for detaching or separating the mechanical connection between the first and the second connection apparatus, it being possible for the separating force to be provided for example by the first connection apparatus or by the operator. In the contacting state, the connecting force is greater than the separating force, with the result that the first and second connection apparatus are connected to one another. As soon as the connecting force is lower than the separating force, for example by detaching a corresponding screw connection, the spacer device can change to the basic state.

The spacing, provided by the spacer device in the basic state, between the first conductor and the coupling component is also referred to as the basic spacing herein. The arrangement described above makes it possible to select the basic spacing when the system is being designed on the basis of the high voltage intended for the first and the second conductor and a predefined class of cleanliness of the first connection apparatus. Furthermore, depending on whether lower/higher system voltages are envisaged, a comparatively small/large basic spacing may correspondingly be required. The above-described arrangement makes it possible to particularly easily select a correspondingly smaller/larger basic spacing when the system is being designed. In this way, a leakage path for the insulation of the first conductor, for example the protective cover, can also be made sufficiently safe. This makes it possible to improve the resistance to leakage currents and the dielectric strength of the first connection apparatus.

Furthermore, in the contacting state the spacer device can be configured to automatically switch to the basic state under the action of the separating force. To this end, the spacer device may be in the form of an automatic mechanism for spacing the coupling component apart from the first conductor under the action of an automatically generated separating force. For example, the automatic mechanism may be provided in the form of a spring mechanism, a pneumatic mechanism, a magnetic mechanism or a gravitational force-based mechanism. In this way, the separating force can be provided particularly easily.

If the device is in the form of a spring mechanism, the spacer device may comprise an electrically insulating spring device with respect to the first conductor, the spring device comprising an electrically non-conductive material or being supported on the protective cover. For example, the spring device may be supported on a projection of the protective cover, the projection being located between the spring device and the first conductor. The spring device allows the spacer device to have a particularly robust and simple structure.

Furthermore, the spring device may comprise an electrically non-conductive material by for example a spring of the spring device being made of an electrically non-conductive material or by for example applying an electrically non-conductive, i.e. insulating, coating to the spring or the spring device.

Furthermore, the coupling component may be in the form of a sleeve and have at least one radial projection, for example in the form of a radially protruding flange, which is configured to engage with the spacer device. The coupling component having the form of a sleeve makes it possible to particularly easily guide the second connecting means of the second connection apparatus through the coupling component in the form of a sleeve, in order to engage in the first connecting means of the first connection apparatus. The at least one radial projection allows the coupling component and the spacer device to be brought into engagement with one another particularly easily, with the result that the spacer device can change very robustly between the basic state and the contacting state. For example, the coupling component may have two or three separate radial projections or a peripheral flange as radial projection. In this way, the spacer device and the coupling component can be brought into particularly uniform engagement.

Furthermore, the coupling component in the form of a sleeve may have a height h between its lower and its upper end and the at least one radial projection, for example the flange, may be located in a region between 25% and 99% of the height h. This makes it possible to provide space for the spacer device in the region below 25% of the height h. Furthermore, it is possible to provide space for retaining and/or guide components, for retaining or guiding the coupling component, close to the upper end of the coupling component in the form of a sleeve, i.e. on the other side between 50% and 99% of the height h.

Furthermore, the first connection apparatus may comprise a guide unit for guiding a movement of the coupling component upon transition between the basic state and the contacting state, the guide unit being located on the protective cover. For example, the guide unit may comprise a guide element in the form of a sleeve or at least two guide segments. Furthermore, the guide unit may be electrically insulating. For example, the guide unit, or its components, may be concentric with the coupling component.

In the form of an electrically insulating guide element in the form of a sleeve, the guide unit can at least partially enclose or cover the coupling component and thus provide further contact protection.

If the guide unit comprises the at least two guide segments, a rotation-prevention means for preventing rotation of the first and the second connection apparatus relative to one another can be provided. Furthermore, an asymmetrical arrangement of the guide segments in the sense of the poka-yoke or lock-and-key principle makes it possible to avoid a misalignment between the first and the second connection apparatus during the mechanical connecting.

Furthermore, the guide unit, or its components, may have a delimiting projection. For example, the guide element in the form of a sleeve may have a radial delimiting projection, for example in the form of an inner flange. Furthermore, the at least two guide segments may have a radial delimiting projection, for example by it having an L shape. The delimiting projection may be located at a height above the radial projection of the coupling component, in order to retain or support the latter. The delimiting projection allows the coupling component to be captively retained on the first connection apparatus. The delimiting projection further allows the spacer device to be captively retained on the first connection apparatus.

According to one embodiment, the spring device may comprise a corrugated spring, a helical spring or a set of spring elements. For example, the spring device may be concentric with the coupling component. For example, the coupling component in the form of a sleeve may be concentrically surrounded by the corrugated spring, which in turn is concentrically surrounded, for example retained, by the guide unit, for example in the form of the at least two L-shaped guide segments. The guide unit can be fastened to the protective cover or formed in one piece therewith. The spring device may be made of an electrically conductive material, for example steel, and kept electrically insulated with respect to the first conductor by the projection of the protective cover. Furthermore, the spring device may comprise a compression spring, for example in the form of a conical spring or a volute spring.

An arrangement according to the examples above makes it possible to select steel as the spring material, with the result that the spring device can remain elastic even when subjected to a high connecting force or under a high degree of deformation. In this way, high connecting forces are enabled, and therefore a particularly reliable mechanical and electrical connection between the first and the second connection apparatus can be established.

In addition, in this way, the spring device can particularly easily provide the separating force, in order to particularly reliably switch back to the basic state, for example in order to protect the operator against electric shocks in the course of a mechanical detachment process. This makes it possible to further improve the reversibility of the contact protection.

Furthermore, the first connection apparatus may comprise the first connecting means, for example in the form of a threaded nut or a bayonet socket, for detachable connection to a second connecting means assigned to the second connection apparatus.

Furthermore, the connecting force may be greater than or equal to 5 N. In the present case, the connecting force is understood to mean a force resulting from or required for electrically conductively connecting the first and the second connecting unit to one another. For example, the connecting force can result from a threaded screw as second connecting means being screwed to the threaded nut as first connecting means. In this case, the screw head can exert the connecting force on the second conductor, which in the course of the screwing operation comes into contact with and transfers the connecting force to the coupling component. Of course, the connecting force may have a variable, for example a gradual, profile in the course of the connection process. However, if the connecting force is less than 5 N, the spacer device will not reduce the envisaged spacing in the basic state between the coupling component and the first conductor.

In this way, it is possible to prevent an operator bringing the spacer device into the contacting state by having a body part inadvertently push the coupling component in the direction of the first conductor with a force greater than 5 N. At the same time, when the system is being designed it is therefore possible to select a spring constant which does not weaken the mechanical connection, for example the screw connection. This makes it possible to provide a robust connection combined with improved contact protection.

As an alternative, the connecting force may for example be greater than or equal to any value ranging from 5 to 100 N. In this way, the constructing engineer can customize the first connection apparatus to rule out inadvertent manual actuation by the operator, while at the same time making the screw-connection possible.

Furthermore, in the basic state the spring device can be in biased engagement with the coupling component, for example with its radial projection. For example, in the basic state the spring device can be in biased engagement with the coupling component in such a way that the spring force in the basic state has a value ranging from 5 to 100 N. In this way, the spring force can be set particularly easily during the design process in order to prevent the operator from inadvertently reducing the spacing between the coupling component and the first conductor.

Furthermore, the guide unit can be radially, i.e. horizontally, elastically deformable, with the result that the spring device can be installed with a bias between the coupling component and the first conductor in the course of the pre-assembly. For example, the guide unit may be configured for snap-fit connection to the spring device and/or the coupling component.

For example, the delimiting projection of the guide element in the form of a sleeve may have an insertion bevel for the pre-assembly of the spring device and/or the coupling component. Furthermore, the guide element in the form of a sleeve may have slots or interruptions for improving the deformability for the snap-fit connection. Furthermore, for example the respective L-shaped delimiting projections of the at least two guide segments may have an insertion bevel for the pre-assembly of the spring device and/or the coupling component.

Furthermore, the first connection apparatus may have an electrically insulating main cover, which is configured to enclose, together with the protective cover, the first conductor in sandwich-like fashion. In this way, the first conductor and the coupling component are protected against external influences, as a result of which it is possible to implement their contact-protection function for examplely fail-safe fashion. In addition, the first connection apparatus can thus be particularly easily assembled in the form of a sub-assembly. Furthermore, the main cover may be provided integrally or in one piece with the protective cover.

Furthermore, the protective cover may be configured for positionally fixed installation with the first conductor. As described above, the first conductor is assigned to the first connection apparatus and can be installed therewith to form the first sub-assembly. In the present case, “positionally fixed” means that the position of the first conductor relative to the protective cover essentially cannot be changed in the installed state by design. In this context, “positionally fixed” also means that the relative alignment between the protective cover and the first conductor cannot be changed by means of the spacer device in the basic state or in the contacting state.

The object stated above is furthermore achieved by a second connection apparatus for a drive battery for electrically connecting a second conductor to a first conductor having the features of Claim 9. Further embodiments will become apparent from the dependent claims, the present description and the figures.

Accordingly, a second connection apparatus for a drive battery for electrically connecting a second conductor to a first conductor is proposed. The second conductor is assigned to the second connection apparatus and the first conductor is assigned to a first connection apparatus. The second connection apparatus comprises the second conductor. The second connection apparatus has a second connecting means, for example in the form of a bolt or a screw, for detachable connection to a first connecting means assigned to the first connection apparatus. The second connection apparatus comprises an electrically insulating protective cover, for insulating the second conductor and the second connecting means, and a retaining device for retaining the second connecting means inside the protective cover. The retaining device can change between a basic state, in which the second connecting means and the second conductor are spaced apart from one another, and a contacting state, in which the second connecting means and the second conductor are in electrical contact. In the basic state, the retaining device is configured to change to the contacting state under the action of a connecting force.

The connection apparatuses disclosed herein serve to electrically connect a first (electrical) conductor to a second (electrical) conductor and are suitable for example for use in the high-voltage range (>60 V). The first and the second conductor may for example be in the form of what is referred to as a busbar or bus. Therefore, the first and the second conductor may be rigid or flexible and can carry high voltages or currents. The second connection apparatus can form a sub-assembly, for example a second installation sub-assembly, with the second conductor.

The electrically insulating protective cover for insulating the second conductor and the second connecting means may be made of plastic. Furthermore, the protective cover may have a multi-part structure, for example in order, in the course of a pre-assembly, to particularly easily receive the second electrical conductor and also optionally further components of the second connection apparatus and at the same time to be able to provide good insulation. Since the second conductor and the second connecting means are insulated by the protective cover, the protective cover provides contact protection. In the present context, the insulation of electrical components implies that they are electrically insulated in the sense of contact protection. This includes the possibility both of a complete encapsulation and an encapsulation provided with interruptions, the interruptions being small enough to adequately reduce the risk of the operator making contact with the corresponding electrical components. The degree of risk reduction required in each case can be predefined for example by structural regulations or system design standards. For example, an interruption of the encapsulation or enclosure must be small and robust enough that a predefined standard test finger or a predefined standard test tool cannot be passed through the gap, or can be passed through only by exceeding a predefined force.

According to the disclosure, in the basic state the retaining device is configured to switch to the contacting state under the action of a connecting force. The connecting force can be provided for example in the course of a mechanical connection process for connecting the second connection apparatus to the first connection apparatus, as described above in the context of the first connection apparatus according to the disclosure.

Correspondingly, the second connection apparatus can be brought into engagement with the first connection apparatus, with the result that the connecting force acts on the second connection apparatus in a corresponding engagement region. To this end, for example the second conductor can rest against a component of the first connection apparatus, for example a coupling component, and force can be distributed from the operator in charge of installation, i.e. from the installation tool being used, by the second connecting means of the second connection apparatus to the first connecting means, corresponding to the second connecting means, of the first connection apparatus, with the result that the first and the second connection apparatus move relatively towards one another. This allows the first and the second connecting means to move relatively towards one another in the course of the mechanical connection process. For example, the engagement region on which the connecting force acts may be located between the second connecting means and the retaining device. Since the first and the second connecting means move relatively towards one another and the connecting force acts on the engagement region, the retaining device can switch from the basic state to the contacting state under the action of the connecting force.

By contrast, the second connection apparatus is still in the basic state when the mechanical connection process has not yet been started, and therefore the second connecting means is spaced apart from the second conductor. Since the retaining device is configured to switch to the contacting state, in which the second connecting means and the second conductor are in electrical contact, under the action of the connecting force, it is possible to ensure the second connecting means and the second conductor make electrical contact only in the course of an mechanical connection process carried out as intended. In this way, it is possible to provide effective contact protection for the second connection apparatus, for example for the second connecting means, which is intended to be directly or indirectly touched by the operator, before the mechanical connection process is performed.

Furthermore, since in the contacting state the second connecting means and the second conductor are in electrical contact, a mechanically and electrically particularly robust connection between the second connecting means and the second conductor can be established. For example, this makes it possible to easily establish a metallic connection between the second connecting means and the second conductor.

The spacing, provided by the retaining device in the basic state, between the second conductor and the second connecting means is also referred to as the basic spacing herein. The arrangement described above makes it possible to select the basic spacing when the system is being designed on the basis of the high voltage intended for the first and the second conductor and a predefined class of cleanliness of the second connection apparatus. For instance, a lower/higher class of cleanliness may indicate lower/higher cleanliness requirements in the course of the pre-assembly or during operation of the second connection apparatus, and this may result in a higher/lower degree of contamination in the region of the insulating protective cover. Furthermore, depending on whether lower/higher system voltages are envisaged, a comparatively small/large basic spacing may correspondingly be required. The above-described arrangement makes it possible to particularly easily select a correspondingly smaller/larger basic spacing when the system is being designed. In this way, a leakage path for the insulation of the second conductor, for example the protective cover, can be made sufficiently safe. This makes it possible to improve the resistance to leakage currents and the dielectric strength of the second connection apparatus.

Furthermore, in the context of the present disclosure it has been identified that the proposed retaining device makes it possible to increase the size of the electrical contact surface between the connection partners in comparison with conventional contact protection devices.

In the present context, “cover” and the “protective cover” can be understood to mean any device for insulating electrical component parts, for example a cladding, enclosure, overmoulding or sheath for electrical component parts.

Furthermore, the retaining device may have at least one deformable hook element, wherein, in the basic state, the at least one hook element is engaged with the second connecting means, in order to keep the second connecting means at a spacing from the second conductor. Furthermore, in the basic state, the at least one hook element may be configured to deform when subjected to the connecting force, with the result that it detaches from the engagement with the second connecting means and the retaining device changes to the contacting state. Furthermore, the at least one hook element may be elastically deformable.

This makes it possible to configure the retaining device in the basic state particularly easily and robustly in structural terms to switch to the contacting state under the action of a connecting force. For example, this makes it particularly easy to pre-assemble the second connecting means inside or on the protective cover, by the second connecting means being located on and brought into engagement with the at least one hook element in the course of the pre-assembly. For example, the second connecting means can be pushed or plugged into the retaining device in the course of the pre-assembly by deformation of the at least one hook element.

For example, the retaining device can have two, three or more hook elements. In this way, the second connecting means can be retained securely and robustly by the retaining device.

Furthermore, the at least one hook element can be formed in one piece with the protective cover. This allows the at least one hook element to be made electrically insulating and/or deformable in structurally simple fashion. Furthermore, additional components are not necessary. In this way, the second connection apparatus can be provided with an increased degree of functional integration, since the retaining device can be formed together with the protective cover.

Furthermore, in the contacting state the retaining device can be configured to switch to the basic state under the action of a separating force. This makes it possible to make safe, in addition to the mechanical connection process, a corresponding detachment or separation process, in which the second connection apparatus is detached or separated from the first connection apparatus again. That is to say, under the action of the separating force, the second connection apparatus transitions from the contacting state, in which the second connecting means and the second conductor are in electrical contact, back to the basic state, in which the second connecting means is spaced apart from the second conductor. Therefore, the second conductor and the second connecting means are not electrically conductively connected. Therefore, even if the second conductor is still electrically connected to the first conductor during the mechanical detachment or separation process, there is no electrical connection between the first conductor of the first connection apparatus and the second connecting means, which is directly or indirectly touched by the operator during the detachment or separation process.

In this way, it is possible to provide reversible contact protection for the second connection apparatus which protects the operator against electric shocks both during the mechanical connection process and during the mechanical detachment process.

The separating force is a force, opposed to the connecting force, for detaching or separating the mechanical connection between the first and the second connection apparatus, it being possible for the separating force to be provided for example by the first connection apparatus or by the operator. In the contacting state, the connecting force is greater than the separating force, with the result that the first and second connection apparatus are connected to one another. As soon as the connecting force is lower than the separating force, for example by detaching a corresponding screw connection, the retaining device can change to the basic state.

According to one refinement, the retaining device may comprise a spring device, for example in the form of a corrugated spring or helical spring, which is concentric with the second connecting means and is electrically insulating with respect to the second conductor, the spring device comprising an electrically non-conductive material or being supported on the protective cover, for example on an inner projection of the protective cover, the inner projection being located between the spring device and the second conductor. In the case of insulating support by means of the inner projection of the protective cover, the spring device may be made of an electrically conductive material, for example steel, with the result that the spring device can remain elastic even under the action of a high connecting force or under strong deformation. In this way, high connecting forces are enabled, and therefore a particularly reliable mechanical and electrical connection between the first and the second connection apparatus can be established. Furthermore, the spring device may comprise a compression spring, for example in the form of a conical spring or a volute spring. Furthermore, the separating force can be provided particularly easily by the spring device.

Furthermore, the spring device may comprise an electrically non-conductive material by for example a spring of the spring device being made of an electrically non-conductive material or by for example applying an electrically non-conductive, i.e. insulating, coating to the spring or the spring device.

In addition, the above-described arrangement allows the spring device to particularly reliably switch back to the basic state under the action of the separating force, for example in order to protect the operator against electric shocks in the course of a mechanical detachment process. This makes it possible to further improve the reversibility of the contact protection of the second connection apparatus.

Furthermore, the second connecting means, for example in the form of a threaded screw, a bolt or a bayonet pin, may be configured for detachable connection to a first connecting means, which is part of or assigned to the first connection apparatus.

Furthermore, the second connecting means may have a head for providing a force fit with the second conductor, for example in the form of a screw head, bolt head or bayonet pin head. The head may have a cutout, for example in the form of a peripheral recess, wherein one end of the spring device is supported in insulated fashion with respect to the second conductor and the other end of the spring device being in engagement with the cutout. In this way, the head can be supported in insulated fashion with respect to the second conductor in the basic state and have an uninterrupted or metallic contact-connection with the second conductor in the contacting state.

Furthermore, in the basic state the spring device can be in biased engagement with the second connecting means, for example with its head. For example, in the basic state the spring device can be in biased engagement with the second connecting means in such a way that the spring force in the basic state has a value ranging from 5 to 100 N. In this way, the spring force can be set particularly easily during the design process in order to prevent the operator from inadvertently reducing the spacing between the second connecting means and the second conductor.

Furthermore, the second connecting means may have an insulating portion, for example in the form of a sheath for insulating the second connecting means with respect to the second conductor in a horizontal direction. In the present case, the horizontal direction relates to a direction transverse to a connecting direction, in which the first and the second connecting means move relatively towards one another in the course of the mechanical connection process, and which is also referred to herein as a vertical direction. If the second connecting means is designed for example in the form of a bolt or a threaded screw, in order to be guided through a passage opening of the second conductor, the insulating portion may for example be designed in the form of a peripheral sheath of a centre portion of the second connecting means. In this way, the contact protection for the second connection apparatus can be further improved. For example, in addition to the spacing provided by the retaining device according to the basic state, an additional spacing or insulation in the horizontal direction is present. The insulating portion may further be provided on the second connecting means from injection moulded plastic. In addition or as an alternative, an insulating portion may be provided on or inside the passage opening of the second conductor, in order to provide corresponding horizontal contact protection.

Furthermore, the connecting force may be greater than or equal to 5 N. In the present case, the connecting force is understood to mean a force resulting from or required for electrically conductively connecting the first and the second connection device to one another. For example, the connecting force can result from a threaded screw as second connecting means being screwed to a threaded nut as first connecting means. The screw head can exert the connecting force on the retaining device. If the connecting force is less than 5 N, the retaining device will not reduce the envisaged spacing in the basic state between the second connecting means and the second conductor. In this way, it is possible to prevent an operator bringing the retaining device into the contacting state by having a body part inadvertently push the second connecting means in the direction of the second conductor with a force greater than 5 N.

As an alternative, the connecting force may for example be greater than or equal to any value ranging from 5 to 100 N. In this way, the constructing engineer can customize the second connection apparatus to rule out inadvertent manual actuation by the operator, while at the same time making the screw-connection possible.

If the retaining device comprises the spring device, it is moreover possible, when the system is being designed, to select a spring constant which does not weaken the mechanical connection, for example the screw connection. This makes it possible to provide a robust connection combined with improved contact protection. If the retaining device comprises the at least one deformable hook element, a corresponding stiffness for the at least one hook element can be selected correspondingly when the system is being designed.

The object stated above is furthermore achieved by a drive battery for an electric vehicle, having the features of Claim 15. Further embodiments will become apparent from the present description and the figures.

Accordingly, the disclosure proposes a drive battery for an electric vehicle, comprising a first battery unit and a further component, for example a second battery unit, and a first connection apparatus according to the disclosure and/or a disclosed second connection apparatus according to the disclosure for connecting the first battery unit and the further component.

The further component may be a second battery unit or another battery component, such as a busbar, a HV terminal, a switch box or a safety device. Generally speaking, the further component may be any component that is suitable or can be envisaged for being conductively connected to the first battery in the drive battery.

For example, the drive battery may have a first connection apparatus according to the disclosure in combination with a conventional second connection apparatus, or a second connection apparatus according to the disclosure in combination with a conventional first connection apparatus. A conventional first/second connection apparatus is understood to mean that they comprise a first/second conductor, a first/second connecting means and a protective cover for insulating the conductor and the connecting means. However, the conventional first/second connection apparatus does not necessarily comprise the spacer device or retaining device, respectively, according to the disclosure.

A first/second battery unit is understood herein to mean a mains-charged battery unit, for example in the form of a battery cell, a multiplicity of interconnected battery cells, or a pre-assembled battery module comprising battery cells.

Since the first battery unit comprises the first connection apparatus according to the disclosure and/or since the further component comprises the second connection apparatus according to the disclosure, the advantages of improved contact protection according to the description above can be obtained.

### BRIEF DESCRIPTION OF THE DRAWINGS

Further embodiments of the disclosure will be explained in more detail by the following description of the figures, in which, schematically:

FIG. 1 shows a sectional view of a first connection apparatus and a conventional second connection apparatus in a first connection stage according to one exemplary embodiment;

FIG. 2 shows an exploded view of the exemplary embodiment in FIG. 1 without the conventional second connection apparatus;

FIG. 3a, b each show a sectional view of the exemplary embodiment in a second and third connection stage, respectively;

FIG. 4a, b each show a further sectional view of the exemplary embodiment in the second and third connection stage, respectively;

FIG. 5a, b, c show various views of a second connection apparatus in a first connection stage according to one exemplary embodiment;

FIG. 6 shows a sectional view of the second connection apparatus in a first connection stage according to a further exemplary embodiment; and

FIG. 7a, b shows a drive battery comprising a first and a second connection apparatus.

### DETAILED DESCRIPTION

Exemplary embodiments are described below with reference to the figures. In this case, identical, similar or functionally identical elements in the various figures are provided with identical reference signs, and a repeated description of these elements is in some cases dispensed with in order to avoid redundancies.

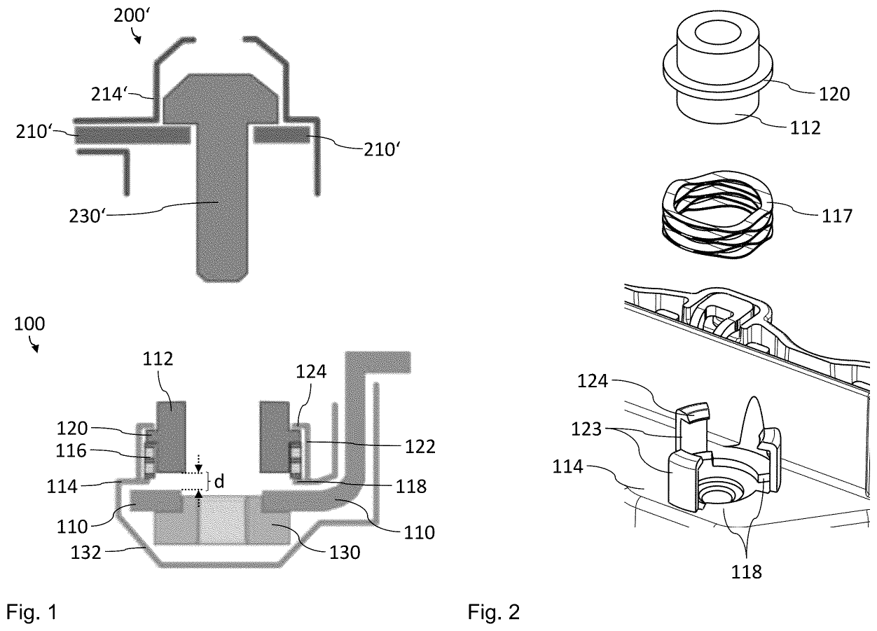

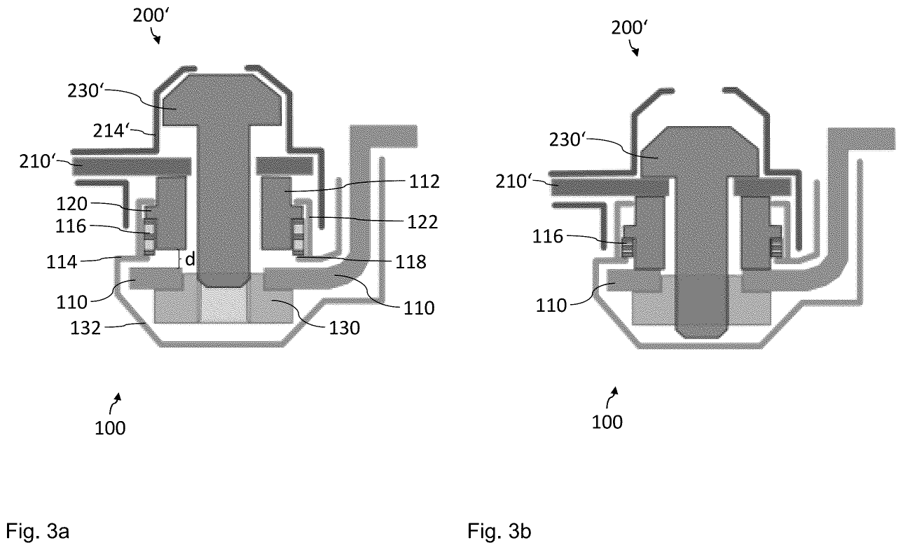

FIG. 1 schematically represents a sectional view of a first connection apparatus 100 in a first connection stage according to a first exemplary embodiment, together with a conventional second connection apparatus 200′. FIG. 2 schematically represents an exploded view of the first connection apparatus 100 in FIG. 1.

The upper part of FIG. 1 represents a conventional second connection apparatus 200′ comprising a second conductor 210′ in the form of a busbar 210′ and a second connecting means 230′ in the form of a threaded screw 230′. The conventional second connection apparatus 200′ further comprises an electrically insulating protective cover 214′ which encapsulates, or encloses, the second conductor 210′ and the second connecting means 230′, in order to provide conventional electrical contact protection for the conventional second connection apparatus 200′.

The lower part of FIG. 1 shows the first connection apparatus 100 according to the disclosure, which can also be referred to as the receiving connection apparatus 100. The first connection apparatus 100 is assigned a first conductor 110, for example in the form of a busbar 110. For example, the first connection apparatus 100 is configured to receive the first conductor 110 in the course of a pre-assembly, with the result that the first conductor 110 is assembled, or pre-assembled, in positionally fixed fashion on or inside the first connection apparatus 100. FIG. 1 shows the first connection apparatus 100 in the pre-assembled state, in which the first connection apparatus 100 comprises the first conductor 110 and a first connecting means 130 which is located on the first conductor and is in the form of a threaded nut 130.

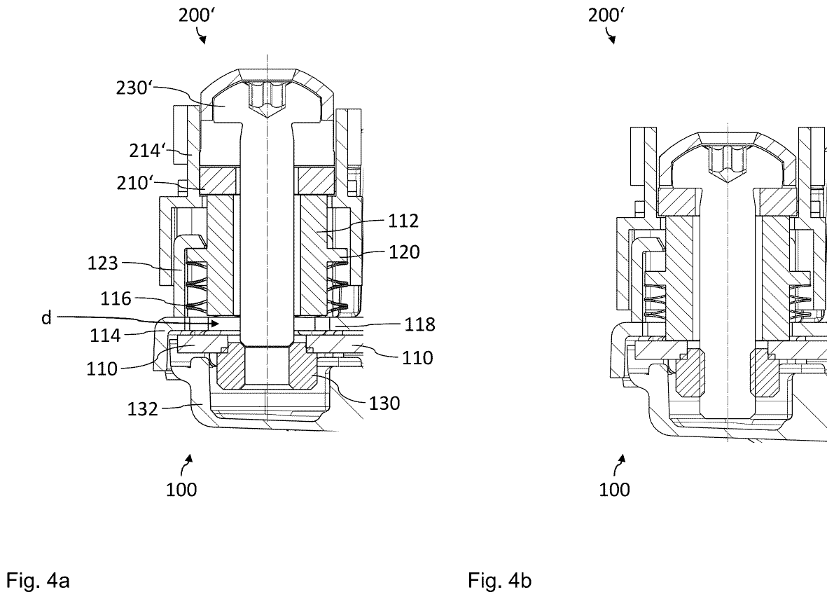

The first connection apparatus 100 furthermore comprises an electrically insulating protective cover 114 for insulating the first conductor 110, an electrically conductive coupling component 112 in the form of a metallic sleeve 112 for electrically coupling to the second conductor 210′, and a spacer device 116 comprising a spring device 116. In a basic state of the spacer device 116, the coupling component 112 is spaced apart from the first conductor 110 by a basic spacing d. This spacing is provided by the spacer device 116. In a contacting state, the coupling component 112 and the first conductor 110 are in electrical contact, for example by resting against one another, the spacing thus being eliminated. The spacer device 116 can change between the basic state represented in FIG. 1 and the contacting state represented for example in FIG. 3b.

The first conductor 110 has a passage opening for guiding the second connecting means 230′ through. The first connecting means 130 is located on an opposite side of the first conductor 110 to the second connection apparatus 200′, in order to be able to be brought into engagement with the second connecting means 230′ for the purpose of mechanically connecting the first and the second connection apparatus.

In the basic state, the spacer device 116 is configured to switch to the contacting state under the action of a connecting force. In the contacting state, the spacer device 116 is configured to switch to the basic state, for example automatically, under the action of a separating force.

The spacer device 116 comprises a spring device 116 with a corrugated spring 117 (see FIG. 2). On the protective cover 114 there is a guide unit 122 for guiding a movement of the coupling component 112 upon transition between the basic state and the contacting state. To this end, the guide unit 122 in this example comprises three L-shaped guide segments, each having radially inwardly pointing delimiting projections 124. As an alternative, it may comprise a guide element which is in the form of a sleeve and has a radially inwardly pointing delimiting projection 124, it being possible for the guide element to have slots or interruptions around the periphery of the sleeve, in order to allow easy pre-assembly of the coupling component 112 and the spacer device 116 (cf. FIG. 2).

The protective cover 114 has a projection 118 which is located substantially in a ring around the passage opening and may optionally have interruptions or slots (see FIG. 2). As an alternative, the projection 118 may also be in the form of a multiplicity of individual projections 118. As for example FIG. 2 shows, the projection 118 or the individual projections 118, and/or the guide unit 122 or the individual guide segments 123, can be formed in one piece with the protective cover 114.

The coupling component 112 has a radial projection 120 in the form of a flange 120 and is clamped between the projection 118 and the delimiting projection 124 by means of the corrugated spring 117 in the course of the pre-assembly (see FIG. 2), with the result that the coupling component is movable axially, i.e. along its main direction of extent and parallel to a connecting direction, to connect the first and the second connection apparatus. Therefore, the corrugated spring 117 is biased in the pre-assembled state and, in conjunction with the guide unit 122 and the projection 118, captively retains the coupling component.

The first connection apparatus 100 additionally has an electrically insulating main cover 132 which, in conjunction with the protective cover 114, encapsulates the first conductor 100 in sandwich-like fashion. The protective cover 114 and the main cover 132 can be form-fittingly connected for example by means of a plug-in or snap-fit connection (not represented). As an alternative, the protective cover 114 and the main cover 132 may be formed in one piece.

The protective cover 114 is configured for positionally fixed installation with the first conductor 110. Optionally, the protective cover 114 is configured for positionally fixed installation, in conjunction with the main cover 132, with the first conductor 110. To this end, the protective cover 114 can for example form-fittingly retain the first conductor alone or in conjunction with the main cover 132.

FIG. 3a represents a sectional view of the first exemplary embodiment in a second connection stage, and FIG. 3b correspondingly represents it in a third connection stage. The first, second and third connection stages relate to successive stages of a mechanical connection process for connecting the first connection apparatus 100 and the second connection apparatus 200′, in order to electrically connect the first conductor 110 and the second conductor 210′ to one another by means of the coupling component 112.

In the first connection stage, the first connection apparatus 100 and the second connection apparatus 200′ are each pre-assembled and are not yet in contact (see FIG. 1). In the subsequent second connection stage, the first connection apparatus 100 and second connection apparatus 200′ make contact, wherein the first connection apparatus 100, i.e. its spacer device 116, is in the basic state, in which the coupling component 112 and the first conductor 110 are spaced apart from one another, for example by the basic spacing d (see FIG. 3a). In the second connection stage, the second conductor 210′ rests on the coupling component 112.

In the subsequent third connection stage, the first connection apparatus 100 and second connection apparatus 200′ make mechanical contact, wherein the first connection apparatus 100, i.e. its spacer device 116, is in the contacting state, in which the coupling component 112 and the first conductor 110 are in electrical contact (see FIG. 3b). As FIG. 3b shows, the second conductor 210′ still rests on the coupling component 112, with the result that the second conductor 210′ is electrically connected to the first conductor 110 by means of the coupling component 112.

The transition from the second connection stage to the third connection stage can be performed by an operator exerting the connecting force on the second connecting means 230′ by hand or by means of an installation tool, with the result that the first and the second connecting means enter into a mechanical connection and the first connection apparatus 100 and the second connection apparatus 200′ move towards one another. This makes it possible to change the spacer device 116 from the basic state to the contacting state under the action of the connecting force. More specifically, the corrugated spring 117 can be compressed under the action of the connecting force. Since the connecting force can have a value of for example 10 N according to the preceding description, an inadvertent switching of the spacer device 116 from the basic state to the contacting state owing to inadvertent contact or actuation by the operator can be avoided. During the design process, any desired value can be selected, for example by means of selecting the spring constant for the corrugated spring 117 or its bias, although the value should of course lie below a final connecting force envisaged to establish the mechanical connection between the first connecting means 130 and the second connecting means 230′.

Furthermore, it is possible to provide a fourth stage which follows the third connection stage and in which the arrangement is analogous to the second stage in the basic state. The fourth stage, which corresponds analogously to the representation according to FIG. 3a, can also be referred to as a detachment or separation stage. Since in the contacting state, and thus in the third stage (see FIG. 3b), the spacer device 116 is configured to switch to the basic state under the action of the separating force, contact protection for the operator performing the mechanical detachment process can be provided upon the transition from the third to the fourth stage. In this way, it is possible to provide reversible contact protection which protects the operator against electric shocks both during the mechanical connection process and during the mechanical detachment or separation process. For example, the second connecting means 230′ in the form of a threaded screw 230′ or a bayonet pin can be detached by the operator from the engagement with the first connecting means 130 in the form of a threaded nut 130 or a bayonet socket. With the detachment of this engagement, the spacer device 116 can, by means of the corrugated spring 117, create a spacing between the first conductor 110 and the coupling component 112 again, for example provide the basic spacing d again.

Since the spacing device 116 is supported in insulated fashion with respect to the first conductor 110, a metal spring, for example in the form of the corrugated spring 117, can be used for the spacer device 116, the spring properties of this metal spring not being weakened by the final connecting force exerted in the third connection stage. In this way, reversible contact protection can be particularly robustly and repeatably provided. As an alternative, the spacer device 116 may comprise a spring device having non-metallic or electrically insulating springs.

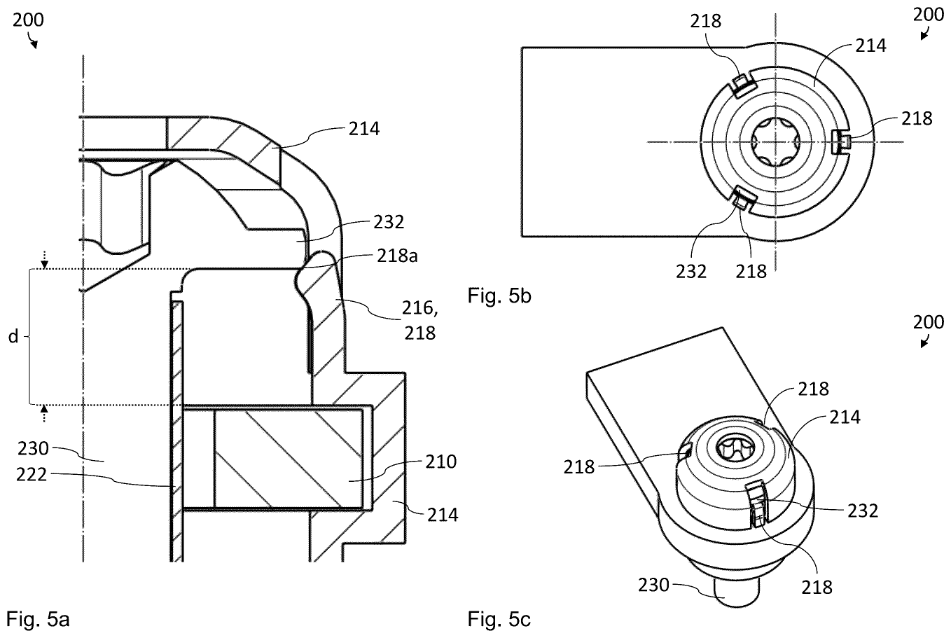

FIG. 4a, b each again show, more specifically, a further sectional view of the exemplary embodiment in FIG. 3a, b in the second and third connection stage, respectively.

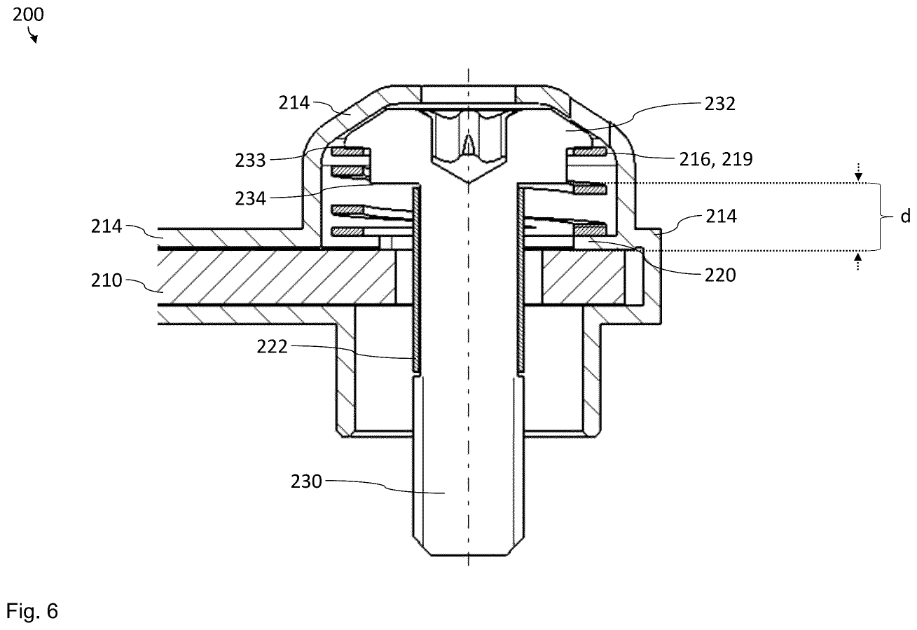

FIG. 5a shows a sectional view of a detail of a second connection apparatus 200 in a first connection stage according to one exemplary embodiment. FIG. 5b shows a plan view and FIG. 5c shows a perspective view of the example in the first connection stage.

Correspondingly to the first connection apparatus 100 according to the disclosure, which can also be referred to as the receiving connection apparatus 100, the second connection apparatus 200 according to the disclosure can also be referred to as the connection apparatus 200 that is to be received. In all the embodiments, a second conductor 210, for example in the form of a busbar 210, is assigned to the second connection apparatus 200. For example, the second connection apparatus 200 is configured to receive the second conductor 210 in the course of a pre-assembly, with the result that the second conductor 210 is assembled, or pre-assembled, in positionally fixed fashion on or inside the second connection apparatus 200. FIGS. 5a-c show the second connection apparatus 200 in the pre-assembled state, in which the second connection apparatus 200 comprises the second conductor 210 and a second connecting means 230 which is located on the second conductor and is in the form of a threaded screw 230.

The second connection apparatus 200 is configured for electrically connecting the second conductor 210 to a first conductor 110, 110′, which may be part of a first connection apparatus 100 according to the disclosure (see for example FIGS. 1 to 4) or of a conventional second connection apparatus 200′ (see for example FIGS. 1 to 4).

Furthermore, the second connection apparatus 200 comprises the second connecting means 230 in the form of the threaded screw 230 for detachable connection to a first connecting means 130, 130′ which is part of the first connection apparatus 100, 100′. Furthermore, the second connection apparatus 200 comprises an electrically insulating protective cover 214, for insulating the second conductor 210 and the second connecting means 230, and a retaining device 216 for retaining the second connecting means 210 inside the protective cover 214. The protective cover 214 for example has a multi-part structure, its parts being able to be form-fittingly connected in the course of a pre-assembly in order to encase, for example encapsulate in sandwich-like fashion, the second conductor 210 and the second connecting means 230 after the pre-assembly. As an alternative, the protective cover 214 may have a single-piece or one-part design.

In all the embodiments, the retaining device 216 can change between a basic state, in which the second connecting means 230 and the second conductor 210 are spaced apart from one another, for example by a basic spacing d, and a contacting state, in which the second connecting means 230 and the second conductor 210 are in electrical contact. In this case, in the basic state the retaining device 216 is configured to change to the contacting state under the action of a connecting force. FIGS. 5a-c show the second connection apparatus and its retaining device in the basic state.

In the example according to FIGS. 5a-c, the retaining device 216 has three deformable hook elements 218 (see FIG. 5b, c). The hook elements 218 are formed in one piece with the protective cover 214 and are electrically insulating. In their non-deformed state, the hook elements 218 protrude into the space enclosed by the protective cover 214, in order to engage with the second connecting means 230 and to keep the latter at the basic spacing d from the second conductor 210. In other words, the hook elements 218 protrude radially inwards in relation to the protective cover 214 in the basic state of the retaining device 216, in order to engage with the second connecting means 230. In the example represented, the retaining device 216 thus retains the head 232 of the threaded screw 230.

In the basic state, the hook elements 218 are configured to deform under the action of the connecting force, with the result that the hook elements 218 detach from the engagement with the second connecting means 230, in order to change the retaining device 216 to the contacting state. The connecting force can be exerted by an operator in charge of installation or their installation tool on the second connecting means 230 in order to mechanically connect the first and the second connecting means. In the course of this connecting process, the first and the second connecting means can move relatively towards one another, wherein the second conductor 210 can rest on the first connection apparatus 100, 100′ so that the first connection apparatus 100, 100′ provides a stop for the second conductor 210. This allows the second connecting means 230 and the second conductor 210 to move relatively towards one another, for example, the head 232 can shift towards the second conductor 210.

The hook elements 218 may each have an oblique portion 218a which, in the basic state, is in engagement with the second connecting means 230, for example the head 232. This makes it possible for the second connecting means 230, for example the head 232, to deform, for example radially outwardly deform, the hook elements 218 by way of the above-described relative movement and allows the second connecting means 230, for example the head 232, to come out of the engagement position.

In FIGS. 5a-c, the hook elements 218 are located substantially in a region between the head 232 and the second conductor 210, with the result that the hook elements 218 support the head 232 under compressive loading with respect to the second conductor 210. As an alternative, the at least one hook element can keep the second connecting means 230 under tensile loading. For example, three hook elements may be located above the head 232 on the protective cover 214 and each retain the head 232 by means of a retaining lug comprising an oblique portion.

In all the embodiments, the second connecting means 230 may optionally have an insulating portion 222 in the form of an insulating sheath 222 which, in the basic state, electrically insulates the second connecting means 230 with respect to the second conductor 210. As FIG. 5a represents, the sheath 222 can enclose the shaft of the threaded screw 230 all around the periphery. In this way, in the basic state, the second connecting means 230 can be provided with electrical isolation with respect to the second conductor in a vertical, i.e. axial, direction and additionally in a horizontal, i.e. radial, direction in the sense of contact protection for the operator.

In all the embodiments, the first and the second conductor may each have a passage opening for passing the second connecting means 230 through. The first connecting means 130, 130′ may be located on an opposite side of the first conductor 110 to the second connection apparatus 200, 200′, in order to be able to be brought into engagement with the second connecting means 230′ for the purpose of mechanically connecting the first and the second connection apparatus.

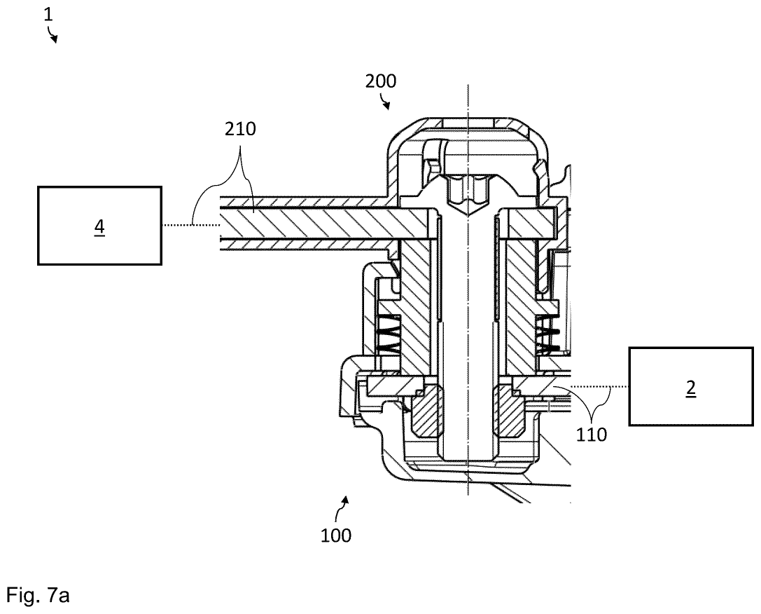

FIG. 6 shows a sectional view of the second connection apparatus 200 in the first connection stage according to a further exemplary embodiment, the example according to FIG. 6 differing from the example in FIGS. 5a-c substantially in terms of the design of the retaining device 216. In FIG. 6, the retaining device 216 comprises a spring device 219, in the form of a helical spring, which is concentric with the second connecting means 230 and is supported in insulated fashion with respect to the second conductor 210. To this end, the protective cover 214 has an inner projection 220, on which the spring device 219 is supported in insulated fashion with respect to the second conductor 210. The inner projection 220 may be in the form of a ring concentrically around the passage opening of the second conductor 210. The inner projection 220 may have interruptions around its periphery, as can be seen in the cross-sectional view in FIG. 6, or may be formed without interruptions.

The head 232 of the second connecting means has a cutout 233 in the form of a peripheral recess 233. In the pre-assembled state, the spring device 219 is clamped between the inner projection 220 and the cutout 233. As a result, one end of the spring device 219 is supported by the inner projection 220 in insulated fashion with respect to the second conductor 210 and the other end of the spring device is in engagement with the cutout 233. In this way, the head 232 can be supported in insulated fashion with respect to the second conductor 210 in the basic state and have a metallic contact-connection, via its head underside 234, with the second conductor 210 in the contacting state.

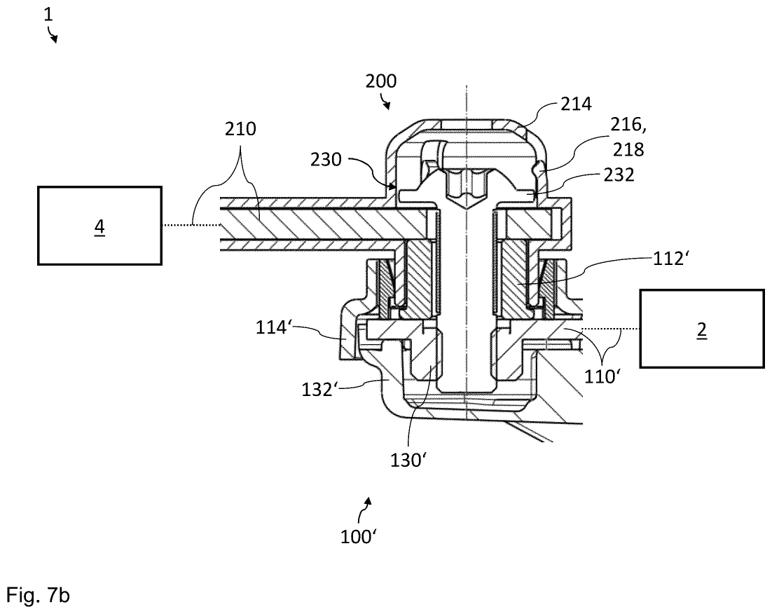

FIG. 7a shows a drive battery 1 comprising a first connection apparatus 100 according to the disclosure and a second connection apparatus 200 according to the disclosure. The first connection apparatus 100 corresponds to the example in FIGS. 1-4. The second connection apparatus 200 corresponds to the example in FIGS. 5a-c. The drive battery 1 comprises a first battery unit 2, which is connected to the first conductor 110 of the first connection apparatus 100, and a further component 4, for example in the form of a second battery unit 4 or further busbar 4, which is connected to the first conductor 210 of the second connection apparatus 200.

As an alternative, the drive battery 1 may comprise the first connection apparatus 100 according to the disclosure and a conventional second connection apparatus 200′ according to FIGS. 1, 3a and 3b.

As represented in FIG. 7b, the drive battery 1 may alternatively comprise the second connection apparatus 200 according to the disclosure and a conventional first connection apparatus 100′. The conventional first connection apparatus 100′ comprises a first conductor 110′, to which a first battery unit 2 is connected, and also a coupling sleeve 112′, a protective cover 114′ with a main cover 132, and a threaded nut 130′. The second connection apparatus 200 and its retaining device 216 are in the third connection stage in FIG. 7b, so that the second connecting means 230, for example by means of its head 232, electrically contacts the second conductor 210. The second conductor 210 in turn rests on the first connection apparatus 100′, for example on its coupling sleeve 112′, which rests on the first conductor 110′, with the result that the second conductor 210 and the first conductor 110′ and thus the first battery unit 2 and the further component 4 are electrically connected to one another.

In all the embodiments of the second connection apparatus 200, the latter may be in a first, second, third and optionally fourth connection stage, which correspond substantially to the connection stages of the first connection apparatus 100 according to the disclosure. The first, second and third connection stages relate to successive stages of a mechanical connection process for connecting the first connection apparatus 100′ and the second connection apparatus 200, in order to electrically connect the first conductor 110′ and the second conductor 210 to one another by means of the coupling component 112′.

In the first connection stage, the first connection apparatus 100 and the second connection apparatus 200′ are each pre-assembled and are not yet in contact (analogous to FIG. 1). In the subsequent second connection stage, the first connection apparatus 100′ and second connection apparatus 200 make contact, wherein the second connection apparatus 200, i.e. its retaining device 216, is in the basic state, in which the second connecting means 230 is spaced apart from the second conductor 210, for example by the basic spacing d (see FIGS. 5a and 6). In the second connection stage, the second conductor 210 rests on the coupling component 112′.

Again looking at FIG. 7b, in the subsequent third connection stage the first connection apparatus 100′ and second connection apparatus 200 make mechanical contact, wherein the second connection apparatus 200, i.e. its retaining device 216, is in the contacting state, in which the second connecting means 230 and the second conductor 210 are in electrical contact. As the figure shows, the second conductor 210 still rests on the coupling component 112′, with the result that the second conductor 210 is electrically connected to the first conductor 110′ via the coupling component 112′.

The transition from the second connection stage to the third connection stage can be performed by an operator exerting the connecting force on the second connecting means 230 by hand or by means of an installation tool, with the result that the first and the second connecting means enter into a mechanical connection and the first connection apparatus 100′ and the second connection apparatus 200 move towards one another. This makes it possible to switch the retaining device 216 from the basic state to the contacting state when subjected to the connecting force.

More specifically, for example the hook elements 218 or the spring device 219 can thus be elastically deformed when subjected to the connecting force. Since the connecting force can have a value of for example 10 N according to the preceding description, an inadvertent switching of the retaining device 216 from the basic state to the contacting state owing to inadvertent contact or actuation by the operator can be avoided. During the design process, any desired value can be selected, for example by means of selecting the spring constant for the spring device 219 or its bias, although the value should of course lie below a final connecting force envisaged to establish the mechanical connection between the first connecting means 130′ and the second connecting means 230.

Furthermore, it is possible to provide a fourth stage which follows the third connection stage and in which the arrangement is analogous to the second stage in the basic state. The fourth stage can also be referred to as a detachment or separation stage. Since the retaining device 216 comprises the spring device 219 and, in the contacting state and thus in the third stage, is configured to switch to the basic state under the action of the separating force, contact protection for the operator performing the mechanical detachment process can be provided upon the transition from the third to the fourth stage. In this way, it is possible to provide reversible contact protection which protects the operator against electric shocks both during the mechanical connection process and during the mechanical detachment or separation process. For example, the second connecting means 230 in the form of a threaded screw 230 or a bayonet pin can be detached by the operator from the engagement with the first connecting means 130′ in the form of a threaded nut 130′ or a bayonet socket. With the detachment of this engagement, the retaining device 216 can, by means of the spring device 219, create a spacing between the second conductor 210 and the second connecting means 230 again, for example the screw head 232, for example provide the basic spacing d again.

In all the embodiments of the first connection apparatus 100 according to the disclosure, the corrugated spring 117 or the helical spring of the spring device 116 may have parallel ends. Similarly, in all the embodiments of the second connection apparatus 200 according to the disclosure, the corresponding corrugated spring or the helical spring 219 of the spring device 219 may have parallel ends. Parallel ends make it possible to simplify and improve the insulating installation and the pre-assembly.

Insofar as applicable, all individual features set forth in the exemplary embodiments can be combined with one another and/or interchanged without departing from the scope of the disclosure.

### LIST OF REFERENCE SIGNS

1 Drive battery
2 First battery unit
4 Further component
100/100′ First connection apparatus
110/110′ First conductor
112/112′ Coupling component, sleeve
114/114′ Protective cover
116 Spacer device, spring device
117 Corrugated spring
118 Projection of the protective cover
120 Radial projection of the coupling component
122 Guide unit
123 Guide segments
124 Delimiting projection of the guide unit/guide segments
130/130′ First connecting means
132/132′ Main cover
200/200′ Second connection apparatus
210/210′ Second conductor
214/214′ Protective cover
216 Retaining device
218 Hook element
218a Oblique portion
219 Spring device
220 Inner projection
222 Insulating portion, sheath
230/230′ Second connecting means
232 Head
233 Cutout, peripheral recess
234 Head underside

1. A first connection apparatus for a drive battery for electrically connecting a first conductor to a second conductor, wherein the first conductor is assigned to the first connection apparatus and the second conductor is assigned to a second connection apparatus, the first connection apparatus comprising the first conductor, an electrically insulating protective cover for insulating the first conductor, an electrically conductive coupling component for electrically coupling the first conductor to the second conductor, and a spacer device,
wherein the spacer device is configured to change between a basic state, in which the coupling component and the first conductor are spaced apart from one another, and a contacting state, in which the coupling component and the first conductor are in electrical contact,
wherein, in the basic state, the spacer device is configured to change to the contacting state under the action of a connecting force, and
wherein, in the contacting state, the spacer device is configured to change to the basic state under the action of a separating force.

2. The first connection apparatus according to claim 1, wherein the spacer device comprises a spring device electrically insulating with respect to the first conductor, the spring device at least one of: comprising an electrically non-conductive material and being supported on the protective cover on a projection of the protective cover, the projection being located between the spring device and the first conductor.

3. The first connection apparatus according to claim 1, wherein the coupling component is in the form of a sleeve and has at least one radial projection in the form of a flange, which is configured to engage with the spacer device.

4. The first connection apparatus according to claim 1, comprising a guide unit for guiding a movement of the coupling component upon transition between the basic state and the contacting state, the guide unit being located on the protective cover and comprising a guide element in the form of at least one of: a sleeve and at least two guide segments.

5. The first connection apparatus according to claim 4, wherein the spring device comprises a corrugated spring, a helical spring or a set of spring elements, the spring device being concentric with the coupling component.

6. The first connection apparatus according to claim 1, comprising a first connecting means in the form of at least one of: a threaded nut (130) and a bayonet socket, for detachable connection to a second connecting means assigned to the second connection apparatus.

7. The first connection apparatus according to claim 1, wherein the connecting force is at least one of: greater than 5N and equal to 5 N.

8. The first connection apparatus according to claim 1, wherein the protective cover is configured for positionally fixed installation with the first conductor.

9. A second connection apparatus for a drive battery for electrically connecting a second conductor to a first conductor, wherein the second conductor is assigned to the second connection apparatus and the first conductor is assigned to a first connection apparatus,
wherein the second connection apparatus comprises the second conductor,
wherein the second connection apparatus comprises a second connecting means i in the form of at least one of: a bolt and a screw, for detachable connection to a first connecting means assigned to the first connection apparatus,
the second connection apparatus comprising:
an electrically insulating protective cover for insulating the second conductor and the second connecting means, and
a retaining device for retaining the second connecting means inside the protective cover,
wherein the retaining device is configured to change between a basic state, in which the second connecting means and the second conductor are spaced apart from one another, and a contacting state, in which the second connecting means and the second conductor are in electrical contact, and
wherein, in the basic state, the retaining device is configured to change to the contacting state under the action of a connecting force.

10. The second connection apparatus according to claim 9, wherein the retaining device has at least one deformable hook element, wherein, in the basic state, the at least one hook element is engaged with the second connecting means, in order to keep the second connecting means at a spacing from the second conductor, and
wherein, in the basic state, the at least one hook element is configured to deform under the action of the connecting force, with the result that it detaches from the engagement with the second connecting means, in order to change the retaining device to the contacting state.

11. The second connection apparatus according to claim 10, wherein the at least one hook element is formed in one piece with the protective cover.

12. The second connection apparatus according to claim 9, wherein, in the contacting state, the retaining device is configured to change to the basic state under the action of a separating force.

13. The second connection apparatus according to claim 12, wherein the retaining device comprises a spring device in the form of at least one of: a corrugated spring and a helical spring, which is concentric with the second connecting means and is electrically insulating with respect to the second conductor, the spring device at least one of: comprising an electrically non-conductive material and being supported on the protective cover on an inner projection of the protective cover, the inner projection being located between the spring device and the second conductor.

14. The second connection apparatus according to claim 9, wherein the second connecting means has an insulating portion in the form of a sheath, for insulating the second connecting means with respect to the second conductor in a horizontal direction.

15. A drive battery for an electric vehicle, comprising a first battery unit and a second battery unit, and at least one of: a first connection apparatus and a second connection apparatus for connecting the first battery unit and the second battery unit.
